(19) United States
(12) Patent Application Publication
(10) Pub. No.: US 2026/0274238 A1
(43) Pub. Date: Sep. 17, 2026

(54) BRAKING DEVICE AND VEHICLE DRIVING DEVICE INCLUDING THE SAME

(71) Applicant: AISIN CORPORATION, Kariya (JP)

(72) Inventors: Hiroshi ISONO, Kariya-shi (JP); Katsuhiro TSUJIMOTO, Kariya-shi (JP)

(73) Assignee: AISIN CORPORATION, Kariya (JP)

(21) Appl. No.: 19/559,125

(22) Filed: Mar. 6, 2026

(30) Foreign Application Priority Data
Mar. 13, 2025 (JP) 2025-040493

(51) Int. Cl. B60T 13/74; B60K 1/00; B60K 7/00; F16D 55/224; F16D 55/38; F16D 65/18; F16D 121/24; F16D 125/40; F16D 125/50

(52) U.S. Cl. CPC B60T 13/746; B60K 1/00; B60K 7/0007; F16D 55/224; F16D 55/38; F16D 65/186; B60K 2001/001; B60K 2007/0092; F16D 2121/24; F16D 2125/40; F16D 2125/50

(57) ABSTRACT

A braking device including: a support member; an output member that is rotatable with respect to the support member; and an engagement mechanism that engages and disengages the support member and the output member, wherein a direction along an output axis, which is a rotation axis of the output member, is defined as an axial direction, and the engagement mechanism includes a pair of engagement elements that is arranged to face each other in the axial direction, a pressing member that presses and releases the pair of engagement elements in the axial direction, and a driving device that drives the pressing member.

### CROSS REFERENCE TO RELATED APPLICATIONS

This application is based on and claims priority under 35 U.S.C. § 119 to Japanese Patent Application No. 2025-040493, filed on Mar. 13, 2025, the entire content of which is incorporated herein by reference.

### TECHNICAL FIELD

The present disclosure relates to a braking device including a support member, an output member rotatable with respect to the support member, and an engagement mechanism that engages and disengages the support member and the output member and a vehicle driving device including the braking device.

### BACKGROUND DISCUSSION

An example of such a braking device is disclosed in the following JP 2023-136046 A. Hereinafter, in the description of the background art, reference signs in JP 2023-136046 A are cited in parentheses.

In a braking device (10) of JP 2023-136046 A, an engagement mechanism (3) includes a pair of engagement elements (31, 32) arranged to face each other in an axial direction (L), a pressing member (33) that presses and releases the pair of engagement elements (31, 32) in the axial direction (L), and a driving device (4) that drives the pressing member (33).

The driving device (4) includes a drive source (41) and a linear motion conversion mechanism (42) that converts rotational driving force of the drive source (41) into driving force of the pressing member (33) in the axial direction (L). The linear motion conversion mechanism (42) includes a threaded shaft member (421) that rotates by the rotational driving force of the drive source (41), and a nut member (422) that is connected to the pressing member (33) and is screwed to the threaded shaft member (421).

In this manner, the threaded shaft member (421) rotates in a predetermined direction by the rotational driving force of the drive source (41), so that the nut member (422) moves to one side (L2) in the axial direction (L). As a result, the pressing member (33) connected to the nut member (422) moves to the one side (L2) in the axial direction (L), and presses the pair of engagement elements (31, 32) in the axial direction (L).

In the braking device (10) described above, the threaded shaft member (421) is disposed coaxially with the pair of engagement elements (31, 32), and supports the pressing member (33) through the nut member (422). In such a configuration, since the diameter of the threaded shaft member (421) becomes relatively large and the lead amount of the screw becomes large accordingly, it is necessary to secure large rotational driving force to be transmitted to the threaded shaft member (421). As a result, the size of the driving device (4) is increased.

Therefore, it is desired to realize a technique that facilitates downsizing of the driving device while sufficiently securing the driving force of the driving device in the engagement mechanism of the braking device.

A need thus exists for a braking device and a vehicle driving device including the same which are not susceptible to the drawback mentioned above.

### SUMMARY

A characteristic configuration of a braking device is a braking device including:
a support member;
an output member that is rotatable with respect to the support member; and
an engagement mechanism that engages and disengages the support member and the output member,
in which a direction along an output axis, which is a rotation axis of the output member, is defined as an axial direction,
the engagement mechanism includes a pair of engagement elements that is arranged to face each other in the axial direction, a pressing member that presses and releases the pair of engagement elements in the axial direction, and a driving device that drives the pressing member,
the driving device includes
a first drive source,
a plurality of output shafts,
a first power transmission mechanism that transmits driving force of the first drive source to the plurality of output shafts, and
a linear motion conversion mechanism that is provided between the pressing member and each of the plurality of output shafts and converts rotational driving force of the each of the plurality of output shafts into driving force of the pressing member in the axial direction,
the first power transmission mechanism includes a plurality of pinions, a carrier that is supported by the support member and rotatably supports the plurality of pinions, and a transmission gear that is a sun gear or a ring gear that meshes with the plurality of pinions,
the driving force of the first drive source is transmitted to one of the plurality of pinions or the transmission gear, and
each of the plurality of pinions is connected to a corresponding one of the plurality of output shafts so as to rotate integrally with the corresponding one of the plurality of output shafts.

A characteristic configuration of a vehicle driving device is a vehicle driving device including:
the braking device;
a second drive source that functions as a drive source of a wheel; and
a second power transmission mechanism that transmits driving force between the second drive source and the wheel,
in which the second power transmission mechanism includes an output rotary element that is connected to the output member.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a braking device according to a first embodiment;

FIG. 2 is a cross-sectional view of a braking device according to a second embodiment;

FIG. 3 is a cross-sectional view of a braking device according to a third embodiment;

FIG. 4 is a cross-sectional view of a braking device according to a fourth embodiment;

FIG. 5 is a cross-sectional view of a vehicle driving device according to a first embodiment;

FIG. 6 is a skeleton diagram of the vehicle driving device according to the first embodiment;

FIG. 7 is a cross-sectional view of a vehicle driving device according to a second embodiment; and

FIG. 8 is a skeleton diagram of the vehicle driving device according to the second embodiment.

### DETAILED DESCRIPTION

### 1. Braking Device According to First Embodiment

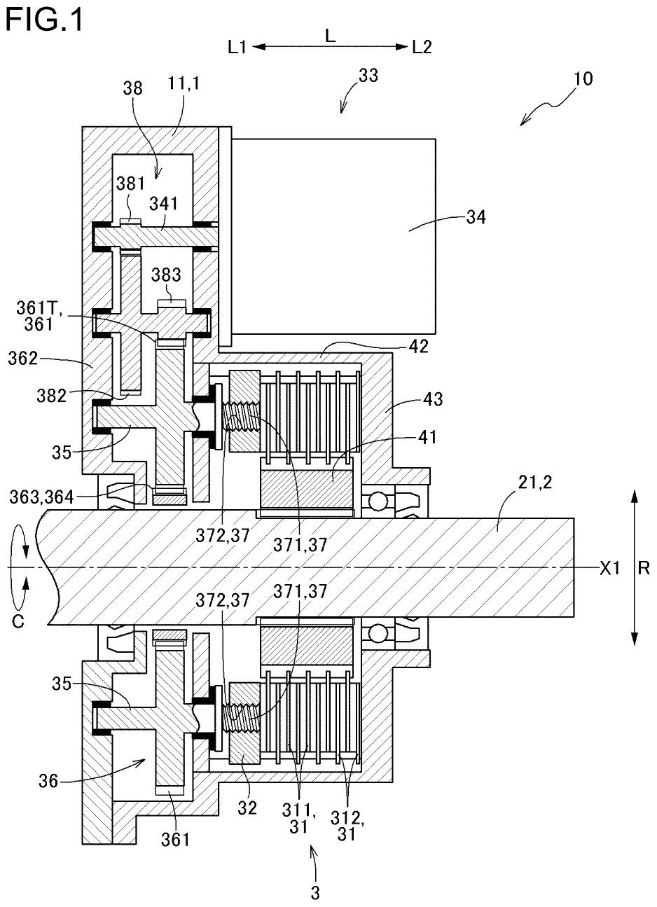

Hereinafter, a braking device 10 according to a first embodiment will be described with reference to FIG. 1.

As illustrated in FIG. 1, the braking device 10 includes a support member 1, an output member 2, and an engagement mechanism 3. In the present embodiment, the support member 1 is a case 11 that accommodates the output member 2 and the engagement mechanism 3.

Here, in the present application, “driving connection” refers to a state in which two rotary elements are connected so as to be able to transmit driving force, and includes a state in which the two rotary elements are connected so as to rotate integrally, or a state in which the two rotary elements are connected so as to be able to transmit driving force through one or at least two transmission members. As such transmission members, various members that transmit rotation at the same speed or at a variable speed, such as a shaft, a gear mechanism, a belt, and a chain are included. Note that as the transmission member, an engagement device that selectively transmits rotation and driving force, for example, a friction engagement device, a meshing engagement device, or the like may be included. However, the term “driving connection” for each rotary element of a planetary gear mechanism refers to a state in which the rotary elements are connected to each other without another rotary element.

The output member 2 is configured to be rotatable with respect to the support member 1. Note that in the following description, a direction along an output axis X1, which is the rotation axis of the output member 2, is referred to as an “axial direction L”. One side in the axial direction L is referred to as a “first side L1 in the axial direction”, and the other side in the axial direction L is referred to as a “second side L2 in the axial direction”. A direction orthogonal to the output axis X1 is referred to as a “radial direction R”. A direction around the output axis X1 is referred to as a “circumferential direction C”.

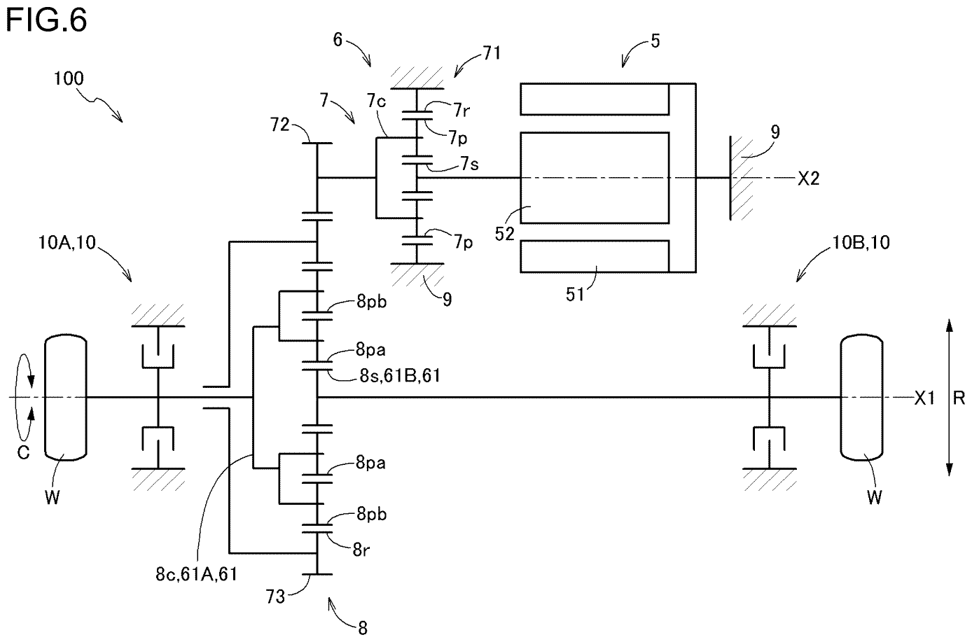

In the present embodiment, the output member 2 includes a drive shaft 21 drivingly connected to a wheel W (see FIG. 6). In the present embodiment, the drive shaft 21 is drivingly connected to the wheel W disposed on the second side L2 in the axial direction with respect to the drive shaft 21.

The engagement mechanism 3 is configured to engage and disengage the support member 1 and the output member 2. The engagement mechanism 3 includes a pair of engagement elements 31, a pressing member 32, and a driving device 33. In the present embodiment, the engagement mechanism 3 further includes a first support body 41, a second support body 42, and a restricting body 43.

The pair of engagement elements 31 is arranged so as to face each other in the axial direction L. The pair of engagement elements 31 includes a first engagement element 311 and a second engagement element 312.

In the present embodiment, a plurality of first engagement elements 311 and a plurality of second engagement elements 312 are provided, and are alternately arranged in the axial direction L. One of the first engagement element 311 and the second engagement element 312 may be a friction plate, and the other may be a separate plate.

The first support body 41 supports the first engagement elements 311 from the inside in the radial direction R. The first support body 41 supports the first engagement elements 311 so as to be non-rotatable with respect to the first support body 41 and movable in the axial direction L. The first support body 41 is connected to the output member 2 so as to rotate integrally therewith. In the present embodiment, a plurality of spline teeth extending in the axial direction L are formed to be dispersed in the circumferential direction C on an outer peripheral portion of the first support body 41. On the other hand, similar spline teeth are also formed on an inner peripheral portion of the first engagement element 311 so as to be dispersed in the circumferential direction C. The spline teeth on the outer peripheral portion of the first support body 41 are engaged with the spline teeth on the inner peripheral portion of the first engagement element 311.

In the present embodiment, the first support body 41 is formed in a cylindrical shape with the output axis X1 as the axis. The first support body 41 is disposed so as to cover the outer periphery of the drive shaft 21. That is, in the present embodiment, the drive shaft 21 is disposed so as to penetrate the first support body 41 in the axial direction L. In the present embodiment, the first support body 41 is connected to the drive shaft 21 so as to rotate integrally therewith.

The second support body 42 supports the second engagement elements 312 from the outside in the radial direction R. The second support body 42 supports the second engagement elements 312 so as to be non-rotatable with respect to the second support body 42 and movable in the axial direction L. The second support body 42 is fixed to the support member 1. In the present embodiment, a plurality of spline teeth extending in the axial direction L are formed to be dispersed in the circumferential direction C on an inner peripheral portion of the second support body 42. On the other hand, similar spline teeth are also formed on an outer peripheral portion of the second engagement element 312 so as to be dispersed in the circumferential direction C. The spline teeth on the outer peripheral portion of the first support body 41 are engaged with the spline teeth on the inner peripheral portion of the first engagement element 311.

In the present embodiment, the second support body 42 is formed in a cylindrical shape with the output axis X1 as the axis. The second support body 42 is disposed outside the first support body 41 in the radial direction R.

The restricting body 43 is disposed on the side opposite to the pressing member 32 in the axial direction L with respect to the pair of engagement elements 31. In the present embodiment, the restricting body 43 is disposed on the second side L2 in the axial direction with respect to the pair of engagement elements 31. The restricting body 43 restricts movement of the pair of engagement elements 31 toward the second side L2 in the axial direction.

The restricting body 43 is fixed to the support member 1. In the present embodiment, the restricting body 43 is formed integrally with the case 11. In the example illustrated in FIG. 1, the restricting body 43 is formed so as to extend inward in the radial direction R from an end portion of the second support body 42 on the second side L2 in the axial direction.

The pressing member 32 is a member that presses and releases the pair of engagement elements 31 in the axial direction L. In the present embodiment, the pressing member 32 is disposed on the first side L1 in the axial direction with respect to the pair of engagement elements 31. In the present embodiment, the pressing member 32 is formed in an annular plate shape with the output axis X1 as the axis. The pressing member 32 is supported so as to be non-rotatable with respect to the second support body 42 and movable in the axial direction L. In the illustrated example, a plurality of spline teeth extending in the axial direction L are formed to be dispersed in the circumferential direction C on an outer peripheral portion of the pressing member 32. The plurality of spline teeth are engaged with the plurality of spline teeth formed on the inner peripheral portion of the second support body 42.

The driving device 33 is a device that drives the pressing member 32. The driving device 33 includes a first drive source 34, a plurality of output shafts 35, a first power transmission mechanism 36, and a linear motion conversion mechanism 37.

The first drive source 34 is configured to output driving force for rotationally driving the plurality of output shafts 35. In the present embodiment, the first drive source 34 is an electric motor. The first drive source 34 is fixed to the case 11. In the present embodiment, the first drive source 34 includes a drive shaft 341 disposed in parallel to the axial direction L. Note that the first drive source 34 preferably includes a lock mechanism that stops rotation of the drive shaft 341. By operating the lock mechanism, the engagement mechanism 3 can function as a parking lock mechanism.

In the present embodiment, the arrangement region of the first drive source 34 in the axial direction L overlaps with the arrangement region of the pair of engagement elements 31 in the axial direction L. In the example illustrated in FIG. 1, the arrangement region of the first drive source 34 in the axial direction L also overlaps with the arrangement region of the pressing member 32 in the axial direction L in addition to the arrangement region of the pair of engagement elements 31 in the axial direction L. Here, regarding arrangement of the two regions, “overlap” means that in a case where a virtual straight line parallel to the line-of-sight direction is moved in each direction orthogonal to the virtual straight line, at least a portion where the virtual straight line intersects both of the two regions exists.

Each of the plurality of output shafts 35 is configured to be rotatable with respect to the support member 1. Each of the plurality of output shafts 35 is formed to extend along the axial direction L. In the present embodiment, the plurality of output shafts 35 are arranged to be dispersed in the circumferential direction C so as to face the pressing member 32 from the first side L1 in the axial direction.

The first power transmission mechanism 36 is configured to transmit the driving force of the first drive source 34 to the plurality of output shafts 35. The first power transmission mechanism 36 includes a plurality of pinions 361 each serving as a first element, a carrier 362 serving as a second element, and a transmission gear 363 serving as a third element or a fourth element. The elements (the pinions 361, the carrier 362, and the transmission gear 363) constituting the first power transmission mechanism 36 are arranged in a similar manner as the elements constituting the planetary gear mechanism. In the present embodiment, the first power transmission mechanism 36 further includes a reduction mechanism 38.

Each of the plurality of pinions 361 is connected so as to rotate integrally with the output shaft 35. In the present embodiment, the rotation axis of each of the plurality of output shafts 35 and the rotation axis of each of the plurality of pinions 361 are arranged in parallel to the axial direction L. Furthermore, in the present embodiment, the plurality of pinions 361 are arranged to be dispersed in the circumferential direction C outside the output member 2 (here, the drive shaft 21) in the radial direction R. The output member 2 (here, the drive shaft 21) is disposed so as to penetrate the engagement mechanism 3 in the axial direction L.

The carrier 362 rotatably supports the plurality of pinions 361. The carrier 362 is supported by the support member 1. In the present embodiment, the carrier 362 is formed integrally with the case 11. That is, in the present embodiment, the carrier 362 is supported so as not to be rotatable with respect to the support member 1.

In the present embodiment, the transmission gear 363 is a sun gear 364 serving as the third element that meshes with the plurality of pinions 361. In the present embodiment, the sun gear 364 is disposed so as to cover the outer periphery of the drive shaft 21. The sun gear 364 is disposed at an interval in the radial direction R with respect to the drive shaft 21. That is, in the present embodiment, the drive shaft 21 is disposed so as to penetrate the sun gear 364 in the axial direction L. In the present embodiment, the sun gear 364 is not supported by a bearing, but is supported by the plurality of pinions 361 meshing with the sun gear 364.

The reduction mechanism 38 is configured to decelerate rotation of the first drive source 34 and transmit the rotation to any one of the plurality of pinions 361 or the transmission gear 363. In this manner, the driving force of the first drive source 34 is transmitted to any one of the plurality of pinions 361 or the transmission gear 363.

In the present embodiment, the reduction mechanism 38 includes a first gear 381, a second gear 382, and a third gear 383.

The first gear 381 is connected to the drive shaft 341 of the first drive source 34 so as to rotate integrally therewith. In the present embodiment, the first gear 381 is disposed on the first side L1 in the axial direction with respect to the first drive source 34.

The second gear 382 meshes with the first gear 381. The second gear 382 is formed to have a larger diameter than that of the first gear 381.

The third gear 383 is connected to the second gear 382 so as to rotate integrally therewith. The third gear 383 is formed to have a smaller diameter than that of the second gear 382. In the present embodiment, the third gear 383 is disposed on the second side L2 in the axial direction with respect to the second gear 382.

The third gear 383 meshes with a target pinion 361T, which is one of the plurality of pinions 361. The third gear 383 is formed to have a smaller diameter than that of the target pinion 361T. As described above, in the present embodiment, the reduction mechanism 38 is configured to decelerate rotation of the first drive source 34 and transmit the rotation to the target pinion 361T. That is, in the present embodiment, the driving force of the first drive source 34 is transmitted to any one of the plurality of pinions 361.

The linear motion conversion mechanism 37 is provided between the pressing member 32 and each of the plurality of output shafts 35 (more specifically, on a power transmission path between the pressing member 32 and each of the plurality of output shafts 35), and is configured to convert rotational driving force of each output shaft 35 into driving force of the pressing member 32 in the axial direction L. In the present embodiment, the linear motion conversion mechanism 37 is a feed screw mechanism including a plurality of threaded shaft members 371 and a plurality of nut members 372.

Each of the plurality of threaded shaft members 371 is formed in a cylindrical shape extending along the axial direction L. External threads are formed on an outer peripheral portion of each threaded shaft member 371. The plurality of threaded shaft members 371 are arranged to be dispersed in the circumferential direction C. Each of the plurality of threaded shaft members 371 is connected to the output shaft 35 so as to rotate integrally therewith. In the present embodiment, the plurality of threaded shaft members 371 are disposed on the second side L2 in the axial direction with respect to the plurality of output shafts 35.

Each of the plurality of nut members 372 is configured to be screwed to the threaded shaft member 371. That is, internal threads screwed to the external threads of the threaded shaft member 371 are formed on an inner peripheral portion of each nut member 372. The plurality of nut members 372 are connected to the pressing member 32 so as to move integrally therewith in the axial direction L. In the present embodiment, the plurality of nut members 372 are integrally formed with the pressing member 32. Therefore, with rotation of the plurality of threaded shaft members 371, the pressing member 32 moves in the axial direction L through the plurality of nut members 372 according to the rotation direction of the plurality of threaded shaft members 371 and the direction of the external threads and the internal threads.

In the present embodiment, in a case where the pressing member 32 moves to the second side L2 in the axial direction to press the pair of engagement elements 31, the movement of the pair of engagement elements 31 to the second side L2 in the axial direction is restricted by the restricting body 43. That is, the restricting body 43 supports the pair of engagement elements 31 pressed by the pressing member 32 from the second side L2 in the axial direction. As a result, the pair of engagement elements 31 is connected to each other so as to be relatively non-rotatable, and the engagement mechanism 3 is brought into an engaged state. As described above, in the present embodiment, the second support body 42 that supports the second engagement elements 312 is fixed to the support member 1 (here, the case 11). Therefore, in a case where the engagement mechanism 3 is in the engaged state, the output member 2 (here, the drive shaft 21) connected to the first support body 41 that supports the first engagement elements 311 is not rotatable.

On the other hand, in a case where the pressing member 32 moves to the first side L1 in the axial direction and the pair of engagement elements 31 that has been pressed by the pressing member 32 is released, the pair of engagement elements 31 is relatively rotatable with respect to each other, and the engagement mechanism 3 is in a disengaged state. In a case where the engagement mechanism 3 is in the disengaged state, the output member 2 (here, the drive shaft 21) connected to the first support body 41 that supports the first engagement elements 311 is rotatable with respect to the support member 1 (here, the case 11).

### 2. Braking Device According to Second Embodiment

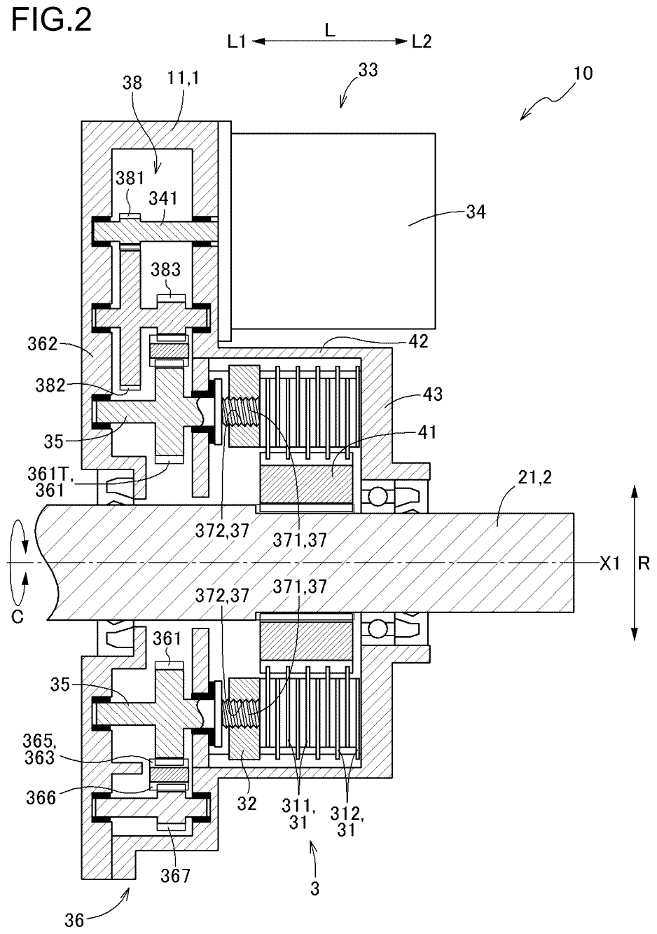

Hereinafter, a braking device 10 according to a second embodiment will be described with reference to FIG. 2. In the present embodiment, the configuration of a first power transmission mechanism 36 is different from that of the braking device 10 according to the first embodiment. Hereinafter, differences from the braking device 10 according to the first embodiment will be mainly described. Note that points not specifically described are similar to those of the braking device 10 according to the first embodiment.

As illustrated in FIG. 2, in the present embodiment, a transmission gear 363 of the first power transmission mechanism 36 is a ring gear 365 serving as a fourth element that meshes with a plurality of pinions 361. As described above, the transmission gear 363 is a sun gear 364 or the ring gear 365 that meshes with the plurality of pinions 361.

In the present embodiment, the first power transmission mechanism 36 further includes an outer peripheral gear 366 and a support gear 367.

The outer peripheral gear 366 meshes with a third gear 383 of a reduction mechanism 38. The outer peripheral gear 366 is formed to have a larger diameter than that of the third gear 383. The outer peripheral gear 366 is formed on an outer peripheral portion of the ring gear 365.

The support gear 367 meshes with the outer peripheral gear 366 at a location in the circumferential direction C different from the location where the third gear 383 meshes with the outer peripheral gear 366. Therefore, the ring gear 365 is supported from the outside in the radial direction R by the support gear 367 and the third gear 383. Note that although not illustrated, in the present embodiment, the plurality of support gears 367 are arranged to be dispersed in the circumferential direction C.

In the present embodiment, the reduction mechanism 38 is configured to decelerate rotation of a first drive source 34 and transmit the rotation to the ring gear 365. That is, in the present embodiment, driving force of the first drive source 34 is transmitted to the ring gear 365 serving as the transmission gear 363.

### 3. Braking Device According to Third Embodiment

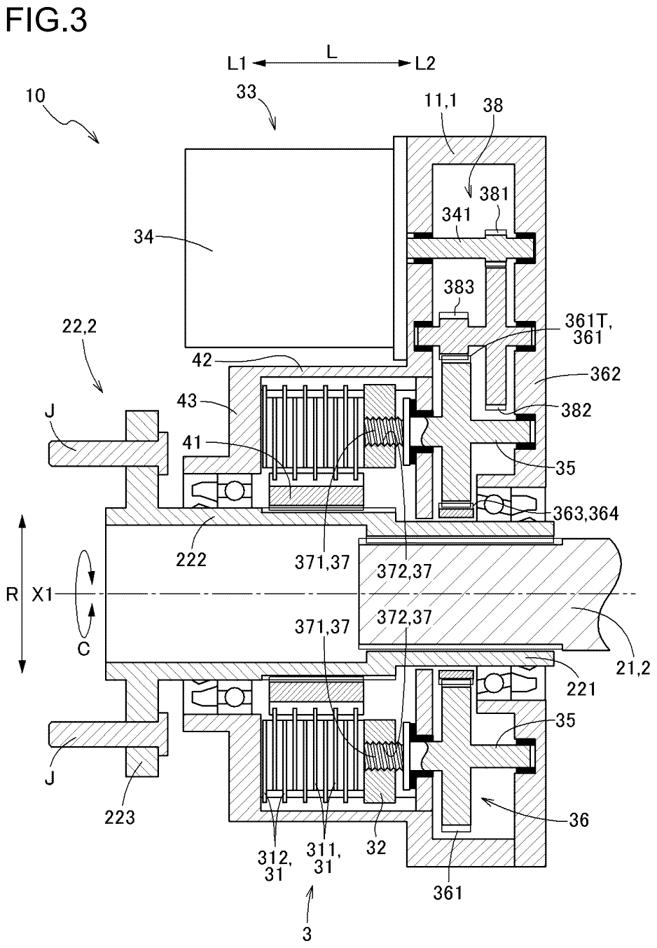

Hereinafter, a braking device 10 according to a third embodiment will be described with reference to FIG. 3. In the present embodiment, the configuration of an output member 2 is different from that of the braking device 10 according to the first embodiment. Hereinafter, differences from the braking device 10 according to the first embodiment will be mainly described. Note that points not specifically described are similar to those of the braking device 10 according to the first embodiment.

As illustrated in FIG. 3, in the present embodiment, the output member 2 further includes a wheel hub 22 in addition to a drive shaft 21. The wheel hub 22 includes a first connecting portion 221, a second connecting portion 222, and a third connecting portion 223.

The first connecting portion 221 is connected to the drive shaft 21 so as to rotate integrally therewith. In the present embodiment, the first connecting portion 221 is formed in a cylindrical shape with an output axis X1 as the axis. The first connecting portion 221 is disposed so as to cover the outer periphery of the drive shaft 21. In the present embodiment, the first connecting portion 221 is disposed so as to penetrate a first power transmission mechanism 36 in the axial direction L and to be exposed to the outside of a case 11 from the first side L1 in the axial direction.

The second connecting portion 222 is connected to a first support body 41 so as to rotate integrally therewith. In the present embodiment, the second connecting portion 222 is formed in a cylindrical shape with the output axis X1 as the axis. The second connecting portion 222 is disposed inside the first support body 41 in the radial direction R. In the present embodiment, the second connecting portion 222 is formed to extend from the first connecting portion 221 toward the first side L1 in the axial direction. The second connecting portion 222 is disposed so as to protrude from the case 11 toward the first side L1 in the axial direction.

The third connecting portion 223 is configured to be connected to the wheel W (see FIG. 6). In the present embodiment, the third connecting portion 223 is formed so as to extend outward in the radial direction R from a portion of the second connecting portion 222 protruding to the outside of the case 11. The third connecting portion 223 is connected to the wheel W in a state of being disposed on the second side L2 in the axial direction with respect to the wheel W by a plurality of wheel connecting members J arranged to be dispersed in the circumferential direction C.

### 4. Braking Device According to Fourth Embodiment

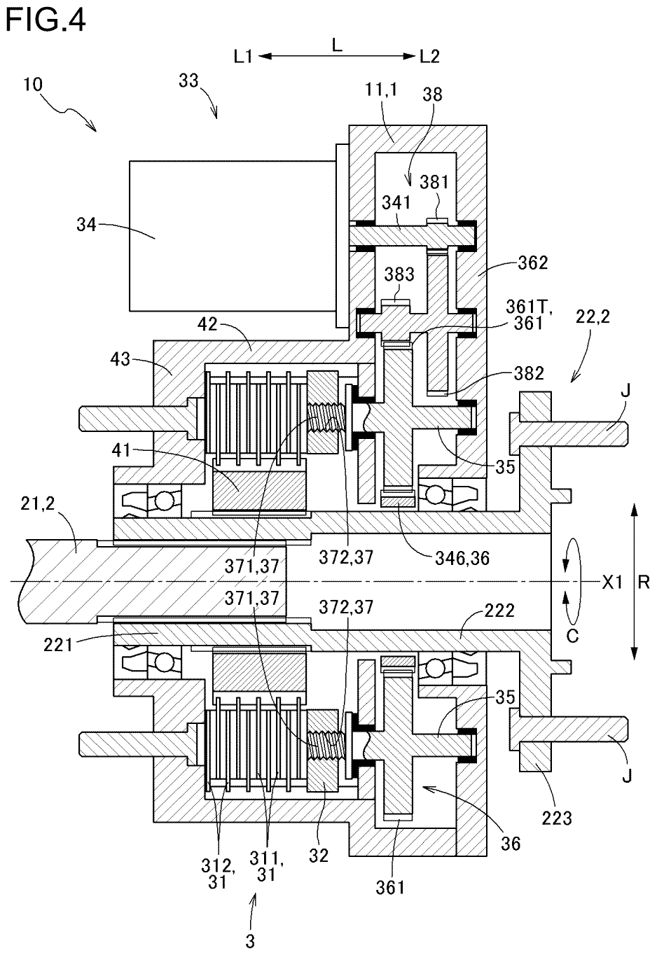

Hereinafter, a braking device 10 according to a fourth embodiment will be described with reference to FIG. 4. In the present embodiment, the configuration of an output member 2 is different from that of the braking device 10 according to the third embodiment. Hereinafter, differences from the braking device 10 according to the third embodiment will be mainly described. Note that points not specifically described are similar to those of the braking device 10 according to the third embodiment.

As illustrated in FIG. 4, in the present embodiment, a first connecting portion 221 is disposed so as to be exposed to the outside of a case 11 from the second side L2 in the axial direction.

In the present embodiment, a second connecting portion 222 is formed to extend from the first connecting portion 221 toward the second side L2 in the axial direction. The second connecting portion 222 is disposed so as to protrude from the case 11 toward the second side L2 in the axial direction.

In the present embodiment, a third connecting portion 223 is connected to the wheel W in a state of being arranged on the first side L1 in the axial direction with respect to the wheel W by a plurality of wheel connecting members J arranged to be dispersed in the circumferential direction C.

### 5. Vehicle Driving Device According to First Embodiment

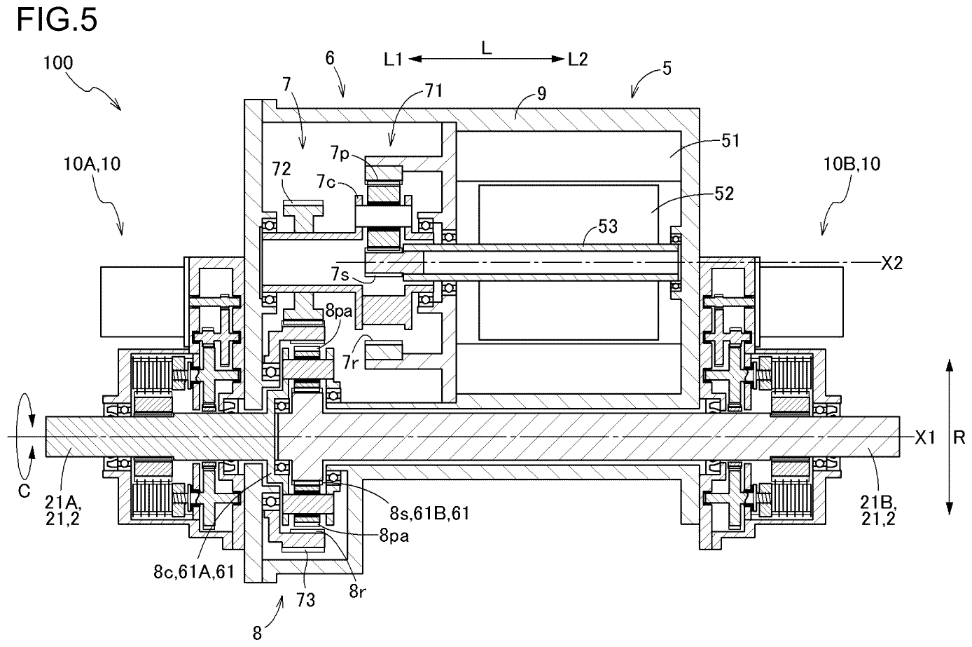

Hereinafter, a vehicle driving device 100 according to a first embodiment will be described with reference to FIGS. 5 and 6.

As illustrated in FIGS. 5 and 6, the vehicle driving device 100 includes the braking devices 10 described above, a second drive source 5, and a second power transmission mechanism 6. In the present embodiment, the vehicle driving device 100 further includes a housing 9 that accommodates the second drive source 5 and the second power transmission mechanism 6.

In the present embodiment, the vehicle driving device 100 includes the pair of braking devices 10. The pair of braking devices 10 is arranged side by side at an interval in the axial direction L. The pair of braking devices 10 is disposed so as to be plane-symmetric with respect to a virtual plane orthogonal to the output axis X1. In the present embodiment, the braking devices 10 (see FIG. 1) according to the first embodiment are used.

Hereinafter, for convenience of description, the braking device 10 on the first side L1 in the axial direction is referred to as a “first braking device 10A”, and the braking device 10 on the second side L2 in the axial direction is referred to as a “second braking device 10B”. Further, the drive shaft 21 which is the output member 2 of the first braking device 10A is referred to as a “first drive shaft 21A”, and the drive shaft 21 which is the output member 2 of the second braking device 10B is referred to as a “second drive shaft 21B”.

The second drive source 5 functions as a drive source of the wheels W. In the present embodiment, the second drive source 5 is disposed on an input axis X2 different from the output axis X1. In the present embodiment, the second drive source 5 is a rotary electric machine including a stator 51 and a rotor 52. Note that the “rotary electric machine” is used as a concept including any of an electric motor, a generator, and a motor-generator that performs functions of the both.

The stator 51 is fixed to a non-rotating member (here, the housing 9). The rotor 52 is rotatably supported with respect to the stator 51. In the present embodiment, the rotor 52 is disposed inside the stator 51 in the radial direction R. That is, in the present embodiment, the second drive source 5 is an inner rotor-type rotary electric machine. The rotor 52 is connected to a rotor shaft 53 extending along the axial direction L so as to rotate integrally therewith.

The second power transmission mechanism 6 is configured to transmit driving force between the second drive source 5 and the wheels W. The second power transmission mechanism 6 includes an output rotary element 61 connected to the output member 2. In the present embodiment, the output rotary element 61 includes a first output rotary element 61A connected to the first drive shaft 21A and a second output rotary element 61B connected to the second drive shaft 21B.

In the present embodiment, the second power transmission mechanism 6 includes a reducer 7 and a differential gear mechanism 8.

The reducer 7 includes a planetary gear mechanism 71, a first reduction gear 72, and a second reduction gear 73.

The planetary gear mechanism 71 decelerates rotation of the rotor 52 and transmits the rotation to the first reduction gear 72. The planetary gear mechanism 71 includes a reduction sun gear 7s, a reduction carrier 7c, and a reduction ring gear 7r. In the present embodiment, the planetary gear mechanism 71 is a single-pinion planetary gear mechanism.

The reduction sun gear 7s is connected to the rotor shaft 53 so as to rotate integrally therewith. The reduction carrier 7c rotatably supports the reduction pinion 7p. The reduction pinion 7p rotates (turns) on the axis thereof and rotates (revolves) around the input axis X2 together with the reduction carrier 7c. In the present embodiment, the reduction pinion 7p meshes with both the reduction sun gear 7s and the reduction ring gear 7r. The reduction ring gear 7r is fixed to a non-rotating member (here, the housing 9).

The first reduction gear 72 is connected to the reduction carrier 7c so as to rotate integrally therewith. The first reduction gear 72 is disposed on the input axis X2.

The second reduction gear 73 meshes with the first reduction gear 72. The second reduction gear 73 is formed to have a larger diameter than that of the first reduction gear 72. The second reduction gear 73 is disposed on the output axis X1.

The differential gear mechanism 8 is configured to distribute rotation of the second reduction gear 73 to the first drive shaft 21A and the second drive shaft 21B. In the present embodiment, the differential gear mechanism 8 is configured by a double-pinion planetary gear mechanism. Therefore, in the present embodiment, the differential gear mechanism 8 includes a differential sun gear 8s, a differential carrier 8c, and a differential ring gear 8r.

The differential ring gear 8r is connected to the second reduction gear 73 so as to rotate integrally therewith. In the present embodiment, the second reduction gear 73 is formed on an outer peripheral portion of the differential ring gear 8r.

The differential carrier 8c rotatably supports a first differential pinion 8pa and a second differential pinion 8pb (see FIG. 6). Each of the first differential pinion 8pa and the second differential pinion 8pb rotates (turns) on the axis thereof and rotates (revolves) around the output axis X1 together with the differential carrier 8c. The first differential pinion 8pa meshes with the differential sun gear 8s. The second differential pinion 8pb meshes with both the first differential pinion 8pa and the differential ring gear 8r.

The differential carrier 8c is connected to the first drive shaft 21A so as to rotate integrally therewith. The differential sun gear 8s is connected to the second drive shaft 21B so as to rotate integrally therewith.

In the vehicle driving device 100 configured as described above, the differential gear mechanism 8 can have a function as a limited slip differential (LSD) mechanism by controlling the engaging force of either the first braking device 10A or the second braking device 10B.

### 6. Vehicle Driving Device According to Second Embodiment

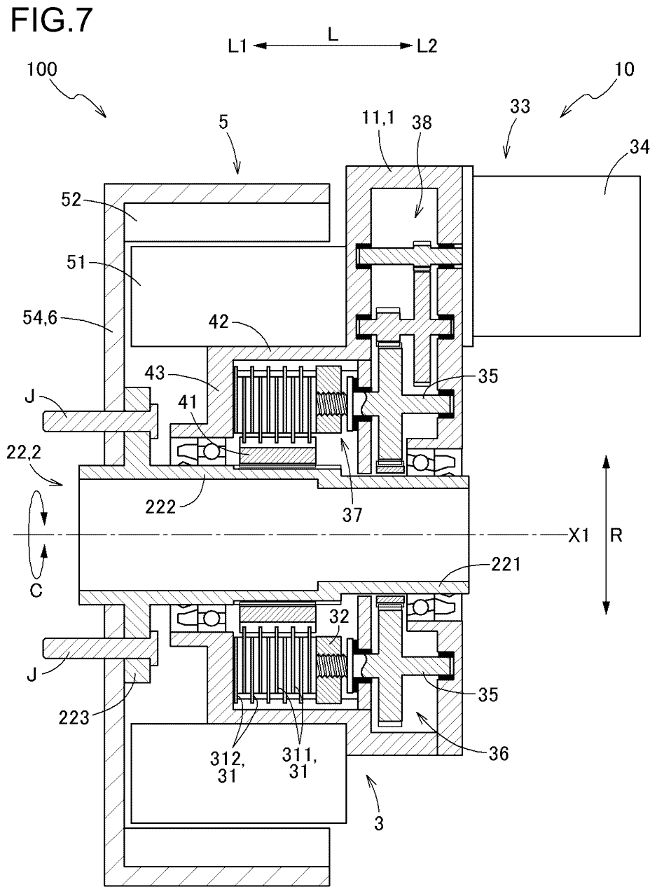

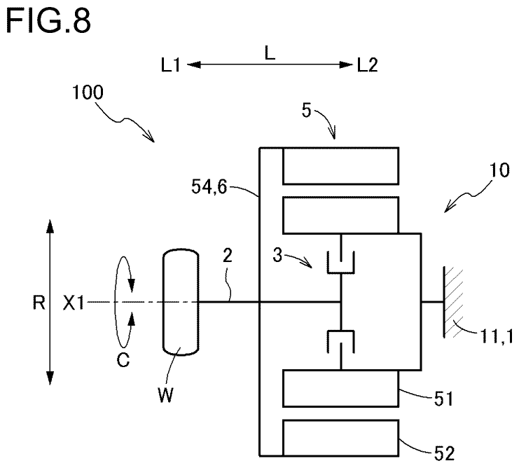

Hereinafter, a vehicle driving device 100 according to a second embodiment will be described with reference to FIGS. 7 and 8.

The present embodiment is different from the first embodiment in that the vehicle driving device 100 is configured as a driving device of the wheel W called an in-wheel motor. Hereinafter, differences from the vehicle driving device 100 according to the first embodiment will be mainly described. Note that points not specifically described are similar to those of the vehicle driving device 100 according to the first embodiment.

As illustrated in FIGS. 7 and 8, in the present embodiment, the vehicle driving device 100 includes one braking device 10. In the present embodiment, the braking device 10 (see FIG. 3) according to the third embodiment is used. However, in the present embodiment, the first drive source 34 is disposed on the second side L2 in the axial direction with respect to the reduction mechanism 38. The arrangement region of the first drive source 34 in the axial direction L does not overlap with the arrangement region of the pair of engagement elements 31 in the axial direction L. In the present embodiment, the output member 2 does not include the drive shaft 21. Note that in the present embodiment, the vehicle driving device 100 does not include the housing 9.

In the present embodiment, a stator 51 is fixed to the case 11 of the braking device 10. A rotor 52 is disposed outside the stator 51 in the radial direction R. That is, in the present embodiment, a second drive source 5 is an outer rotor-type rotary electric machine.

In the present embodiment, the rotor 52 is supported by a rotor support member 54. The rotor support member 54 is connected to the wheel hub 22 so as to rotate integrally therewith. That is, in the present embodiment, the rotor support member 54 functions as a second power transmission mechanism 6 that transmits driving force between the second drive source 5 and the wheel W. In the present embodiment, the rotor support member 54 is connected to the wheel W through the third connecting portion 223 of the wheel hub 22 by the plurality of wheel connecting members J.

### 7. Other Embodiments

(1) In the embodiments described above, the configuration in which the first power transmission mechanism 36 includes the reduction mechanism 38 has been described as an example. However, the present disclosure is not limited to such a configuration, and the first power transmission mechanism 36 may not include the reduction mechanism 38.
(2) In the embodiments described above, the configuration in which driving force of the first drive source 34 is transmitted to any one of the plurality of pinions 361 (see FIG. 1) and the configuration in which driving force of the first drive source 34 is transmitted to the ring gear 365 serving as the transmission gear 363 (see FIG. 2) have been described as examples. However, the present disclosure is not limited to such configurations, and driving force of the first drive source 34 may be transmitted to the sun gear 364 serving as the transmission gear 363.
(3) Note that the configurations disclosed in the above-described embodiments can be applied in combination with the configuration disclosed in another embodiment as long as there is no contradiction. Regarding other configurations, the embodiments disclosed in the present specification are merely examples in all respects. Therefore, various modifications can be appropriately made without departing from the gist of the present disclosure.

### 8. Summary of Embodiments

Hereinafter, an outline of the braking device (10) that has been described above and the vehicle driving device (100) including the same will be described.

The braking device (10) is a braking device (10) including:
a support member (1);
an output member (2) that is rotatable with respect to the support member (1); and
an engagement mechanism (3) that engages and disengages the support member (1) and the output member (2),
in which a direction along an output axis (X1), which is a rotation axis of the output member (2), is defined as an axial direction (L),
the engagement mechanism (3) includes a pair of engagement elements (31) that is arranged to face each other in the axial direction (L), a pressing member (32) that presses and releases the pair of engagement elements (31) in the axial direction (L), and a driving device (33) that drives the pressing member (32),
the driving device (33) includes
a first drive source (34),
a plurality of output shafts (35),
a first power transmission mechanism (36) that transmits driving force of the first drive source (34) to the plurality of output shafts (35), and
a linear motion conversion mechanism (37) that is provided between the pressing member (32) and each of the plurality of output shafts (35) and converts rotational driving force of the each of the plurality of output shafts (35) into driving force of the pressing member (32) in the axial direction (L),
the first power transmission mechanism (36) includes a plurality of pinions (361), a carrier (362) that is supported by the support member (1) and rotatably supports the plurality of pinions (361), and a transmission gear (363) that is a sun gear (364) or a ring gear (365) that meshes with the plurality of pinions (361),
the driving force of the first drive source (34) is transmitted to one of the plurality of pinions (361) or the transmission gear (363), and
each of the plurality of pinions (361) is connected a corresponding one of the plurality of output shafts (35) so as to rotate integrally with the corresponding one of the plurality of output shafts (35).

According to this configuration, the driving force of the first drive source (34) is transmitted to the plurality of output shafts (35) by the first power transmission mechanism (36), and the rotational driving force of each of the plurality of output shafts (35) is converted into the driving force of the pressing member (32) in the axial direction (L) by the linear motion conversion mechanism (37). Thus, the pressing member (32) can be driven in the axial direction (L) at a plurality of locations by the plurality of output shafts (35). Therefore, the rotational driving force of each output shaft (35) necessary for driving the pressing member (32) in the axial direction (L) can be made small. Therefore, it is easy to downsize the driving device (33) while sufficiently securing driving force of the driving device (33) in the engagement mechanism (3).

In addition, according to the present configuration, the first power transmission mechanism (36) that transmits the driving force of the first drive source (34) to the plurality of output shafts (35) includes the plurality of pinions (361) each of which is connected to the output shaft (35) so as to rotate integrally therewith, the carrier (362) that rotatably supports the plurality of pinions (361), and the transmission gear (363) that is the sun gear (364) or the ring gear (365) engaged with the plurality of pinions (361), and the driving force of the first drive source (34) is transmitted to any one of the plurality of pinions (361) or the transmission gear (363). As a result, the plurality of output shafts (35) can be appropriately rotationally driven by the first drive source (34), and the first power transmission mechanism (36) can be easily disposed so as not to interfere with the output member (2).

Here, a direction orthogonal to the output axis (X1) is defined as a radial direction (R), and a direction around the output axis (X1) is defined as a circumferential direction (C),
a rotation axis of the each of the plurality of output shafts (35) and a rotation axis of the each of the plurality of pinions (361) are preferably arranged in parallel to the axial direction (L),
the plurality of pinions (361) are preferably arranged to be dispersed in the circumferential direction (C) outside the output member (2) in the radial direction (R), and
the output member (2) is preferably disposed so as to penetrate the engagement mechanism (3) in the axial direction (L).

According to this configuration, the engagement mechanism (3) can be disposed so as to surround the outer side of the output member (2) in the radial direction (R). Therefore, the degree of freedom in the arrangement of the braking device (10) can be easily increased.

In addition, the first drive source (34) preferably includes a drive shaft (341) that is disposed in parallel to the axial direction (L), and
an arrangement region of the first drive source (34) in the axial direction (L) preferably overlaps with an arrangement region of the pair of engagement elements (31) in the axial direction (L).

According to this configuration, as compared with the configuration in which the first drive source (34) and the pair of engagement elements (31) are arranged to be shifted in the axial direction (L), the dimension of the engagement mechanism (3) in the axial direction (L) can be easily reduced. Therefore, the degree of freedom in the arrangement of the braking device (10) can be easily increased.

The vehicle driving device (100) is a vehicle driving device (100) including:
the braking device (10);
a second drive source (5) that functions as a drive source of a wheel (W);
a second power transmission mechanism (6) that transmits driving force between the second drive source (5) and the wheel (W),
in which the second power transmission mechanism (6) includes an output rotary element (61) that is connected to the output member (2).

According to this configuration, the vehicle driving device (100) can have both functions of driving and braking of the wheel (W). In addition, a wheel brake of the vehicle can be omitted.

The technique according to the present disclosure can be used for a braking device including a support member, an output member rotatable with respect to the support member, and an engagement mechanism that engages and disengages the support member and the output member and a vehicle driving device including the same.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A braking device comprising:
a support member;
an output member that is rotatable with respect to the support member; and
an engagement mechanism that engages and disengages the support member and the output member,
wherein a direction along an output axis, which is a rotation axis of the output member, is defined as an axial direction,
the engagement mechanism includes a pair of engagement elements that is arranged to face each other in the axial direction, a pressing member that presses and releases the pair of engagement elements in the axial direction, and a driving device that drives the pressing member,
the driving device includes
a first drive source,
a plurality of output shafts,
a first power transmission mechanism that transmits driving force of the first drive source to the plurality of output shafts, and
a linear motion conversion mechanism that is provided between the pressing member and each of the plurality of output shafts and converts rotational driving force of the each of the plurality of output shafts into driving force of the pressing member in the axial direction,
the first power transmission mechanism includes a plurality of pinions, a carrier that is supported by the support member and rotatably supports the plurality of pinions, and a transmission gear that is a sun gear or a ring gear that meshes with the plurality of pinions,
the driving force of the first drive source is transmitted to one of the plurality of pinions or the transmission gear, and
each of the plurality of pinions is connected to a corresponding one of the plurality of output shafts so as to rotate integrally with the corresponding one of the plurality of output shafts.

2. The braking device according to claim 1,
wherein a direction orthogonal to the output axis is defined as a radial direction, and a direction around the output axis is defined as a circumferential direction,
a rotation axis of the each of the plurality of output shafts and a rotation axis of the each of the plurality of pinions are arranged in parallel to the axial direction,
the plurality of pinions are arranged to be dispersed in the circumferential direction outside the output member in the radial direction, and
the output member is disposed so as to penetrate the engagement mechanism in the axial direction.

3. The braking device according to claim 1,
wherein the first drive source includes a drive shaft that is disposed in parallel to the axial direction, and
an arrangement region of the first drive source in the axial direction overlaps with an arrangement region of the pair of engagement elements in the axial direction.

4. A vehicle driving device comprising:
the braking device according to claim 1;
a second drive source that functions as a drive source of a wheel; and
a second power transmission mechanism that transmits driving force between the second drive source and the wheel,
wherein the second power transmission mechanism includes an output rotary element that is connected to the output member.

5. A vehicle driving device comprising:
the braking device according to claim 2;
a second drive source that functions as a drive source of a wheel; and
a second power transmission mechanism that transmits driving force between the second drive source and the wheel,
wherein the second power transmission mechanism includes an output rotary element that is connected to the output member.

6. A vehicle driving device comprising:
the braking device according to claim 3;
a second drive source that functions as a drive source of a wheel; and
a second power transmission mechanism that transmits driving force between the second drive source and the wheel,
wherein the second power transmission mechanism includes an output rotary element that is connected to the output member.
